(19) United States
(12) Patent Application Publication
(10) Pub. No.: US 2012/0090875 A1
(43) Pub. Date: Apr. 19, 2012

(54) CONDUCTIVE FILM AND METHOD FOR MANUFACTURING THE SAME

(75) Inventors: Kyoung Soo Chae, Seoul (KR); Yong Soo Oh, Gyeonggi-do (KR); Jong Young Lee, Gyunggi-do (KR); Hee Bum Lee, Gyunggo-do (KR)

(73) Assignee: SAMSUNG ELECTRO-MECHANICS CO., LTD, Gyunggi-do (KR)

(21) Appl. No.: 12/984,376

(22) Filed: Jan. 4, 2011

(30) Foreign Application Priority Data
Oct. 13, 2010 (KR) 1020100099824

(51) Int. Cl. H01B 5/00; B05D 5/12; B31B 1/62

(52) U.S. Cl. 174/126.2; 156/60; 156/319; 427/118

(57) ABSTRACT

Disclosed herein is a conductive film. The conductive film includes: a base member; a transparent electrode formed on the base member; and electrode wirings connected to one side or both sides of the transparent electrode and having a first metal layer formed on the lower portion thereof and a second metal layer made of a metal different from the first metal layer and formed to be thicker than the thickness of the first metal layer stacked on the upper portion thereof.

The conductive film and the method for manufacturing the same form the electrode wirings by stacking the second metal layer on the upper portion of the first metal layer to prevent the second metal layer from being spread to both sides due to the first metal layer. As a result, the present invention can form the fine electrode wirings and reduce the non-display region of the conductive film.

### CROSS REFERENCE TO RELATED APPLICATION

This application claims the benefit of Korean Patent Application No. 10-2010-0099824, filed on Oct. 13, 2010, entitled “Conductive Film And Manufacturing Method” which is hereby incorporated by reference in its entirety into this application.

### BACKGROUND OF THE INVENTION

1. Technical Field

The present invention relates to a conductive film and a method for manufacturing the same.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse which currently serves as the input device. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

The resistive touch panel has a structure in which upper/lower transparent electrode films are disposed to be spaced by a spacer and contact each other by a touch. When an upper conductive film with the upper transparent electrode film is pressed by an input unit such as fingers, pens or the like, an example of a method of recognizing touched coordinates by conducting the upper/lower transparent electrode films to each other and recognizing the change in voltage according to a change in resistance value of the positions by a controller may include a digital resistive type method and an analog resistive type method.

In the case of the capacitive touch panel, as shown in FIG. 1, an upper conductive film (not shown) formed with a first transparent electrode (not shown) and a lower conductive film formed with a second transparent electrode 120 are spaced apart from each other and an insulating material is inserted between the first transparent electrode and the second transparent electrode 120 to prevent them from contacting each other. In addition, the upper conductive film and the lower conductive film are formed with electrode wirings 130 connected to the transparent electrode 120. The electrode wiring 130 transfers the change in capacitance generated from the first transparent electrode and the second transparent electrode 120 to a controller as the input units contact the touch screen.

The touch panel may be divided into a display region R1 through which images generated from an image display device passes and a non-display region R2 surrounding the circumference of the display region R1 and not passing through images, when the lower portion of the touch panel is combined with the image display device.

The display region R1 is a region detecting the coordinates touched by a user, including the transparent electrode 120. The non-display region R2 includes the electrode wirings 130 and is not generally recognized from the outside during the use thereof

Meanwhile, the wiring interval between the electrode wirings 130 formed in the non-display region R2 is a critical factor determining an area of the non-display region R2. The prior art forms the electrode wirings 130 with a conductive paste having high electric conductivity. In this case, a silk screen method, a gravure printing method, an inkjet printing method, or the like, has been used. When the electrode wiring 130 having a predetermined resistance value is formed by the above-mentioned methods, the electrode wiring 130 requires a conductive paste of a predetermined thickness or more. In this case, the conductive paste is spread to both sides, such that there is a risk of causing short between the electrode wirings 130. As a result, there is a limitation in reducing the wiring interval between the electrode wiring 130. Therefore, when the plurality of electrode wirings 130 are formed, the area of the non-display region R2 is increased, such that the display region R1 is relatively reduced and it is difficult to make the touch panel small. Meanwhile, the electrode wiring 130 is formed to be thinner, it is possible to prevent the conductive paste from being spread to both sides but the use thereof is limited due to the high resistance value.

### SUMMARY OF THE INVENTION

The present invention has been made in an effort to form electrode wirings by first forming the first metal layer on a base member and then stacking the second metal layer on the upper portion of the first metal layer to prevent a second metal layer from being spread to both sides due to a first metal layer. Therefore, the present invention can reduce the line width and the wiring interval of the electrode wirings and reduce an area of a non-display region.

A conductive film according to a preferred embodiment of the present invention includes: a base member; a transparent electrode formed on the base member; and electrode wirings connected to one side or both sides of the transparent electrode and having a first metal layer formed on the lower portion thereof and a second metal layer made of a metal different from the first metal layer and formed to be thicker than the thickness of the first metal layer stacked on the upper portion thereof.

The second metal layer may have higher electric conductivity than that of the first metal layer.

The second metal layer may be formed to correspond to a width of the first metal layer.

The first metal layer may be made of any one of gold (Au), nickel (Ni), copper (Cu), chromium (Cr), and titanium (Ti).

The second metal layer may be made of silver (Ag).

The transparent electrode may be formed in plural while extending in a first direction.

The transparent electrode may be formed in a single film shape.

The transparent electrode may be made of a conductive polymer.

The conductive polymer may be any one of polythiophenes, polypyrroles, polyphenylenes, polyanilines, and polyacetylenes.

A method for manufacturing a conductive film according to another preferred embodiment of the present invention includes: (A) forming a transparent electrode on a base member; (B) forming a first metal layer by connecting to one side or both sides of the transparent electrode; (C) forming electrode wirings on the upper portion of the first metal layer by stacking a second metal layer thicker than that the thickness of the first metal layer; and (D) curing the electrode wirings.

At step (A), the transparent electrode may be formed in plural while extending in a first direction.

At step (A), the transparent electrode may be formed in a single film shape.

At step (B), the first metal layer may be formed by a vacuum deposition method.

At step (C), the second metal layer may be stacked to correspond to a width of the first metal layer.

At step (C), the second metal layer may be stacked by any one of a silk screen method, a gravure printing method, and an inkjet printing method.

### BRIEF DESCRIPTION OF THE DRAWINGS

FIG. 1 is a plan view and a partially enlarged view showing a conductive film of a capacitive touch panel according to the prior art;

FIG. 2A is a plan view showing the conductive film of the capacitive touch panel according to a preferred embodiment of the present invention;

FIG. 2B is a partially enlarged view of A shown in FIG. 2A;

FIG. 2C is a plan view showing a conductive film of a resistive touch panel according to a preferred embodiment of the present invention;

FIG. 2D is a partially enlarged view of B shown in FIG. 2C; and

FIGS. 3 to 6 are plan views and cross-sectional views showing a method of manufacturing a conductive film according to a preferred embodiment of the present invention in a process sequence.

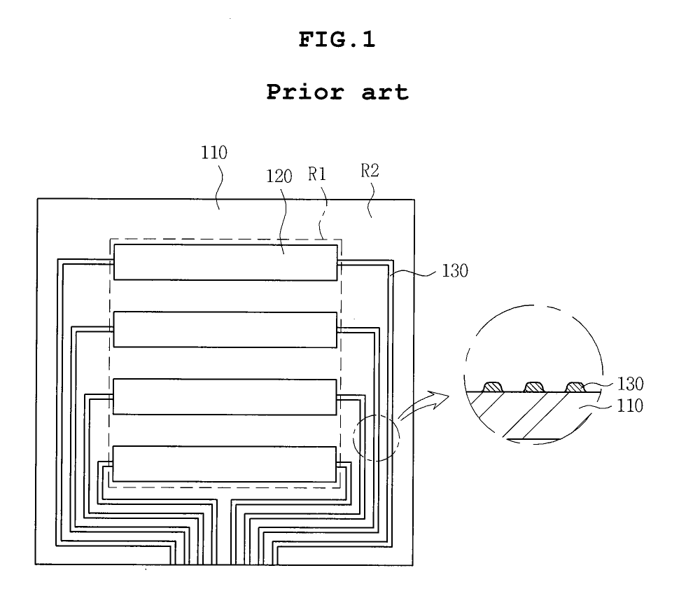

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of a package substrate according to the present invention will be described in detail with reference to the accompanying drawings.

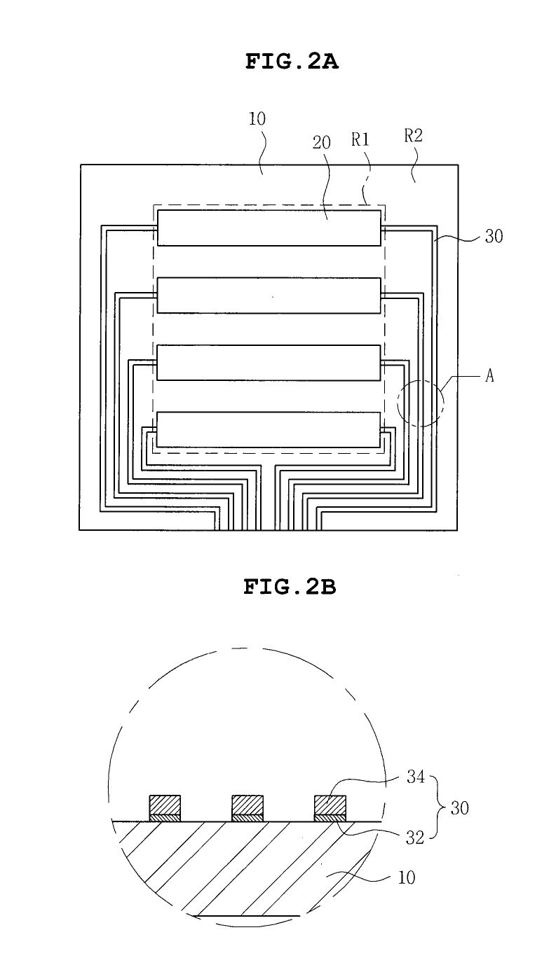

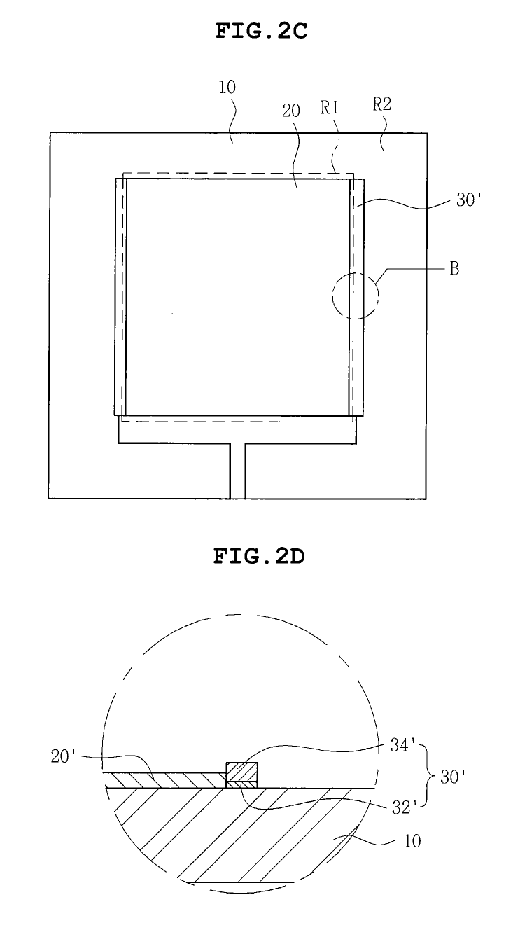

FIG. 2A is a plan view showing a conductive film of a capacitive touch panel according to a preferred embodiment of the present invention. Hereinafter, a capacitive touch panel according to the present invention will be described with reference to FIG. 2A.

The conductive film is configured to include a base member 10, a transparent electrode 20 formed on the base member 10, and electrode wirings 30. The transparent electrode 20 is formed in a display region R1 and the electrode wirings 30 are formed in a non-display region R2.

The electrode wiring 30 has a double layer structure in which a first metal layer 32 is formed on the base member 10 and a second metal layer 34 thicker than the thickness of the first metal layer 32 is stacked on the upper portion of the first metal layer 32 while being made of a metal different from the first metal layer 32, as shown in FIG. 2B. The first metal layer 32 is formed at a thin thickness of several hundred nm and both sides of the first metal layer do not spread. Therefore, the first metal layer may be formed in plural at an interval of 100 μm or less.

In addition, the first metal layer is fixed so that the second metal layer 34 stacked on the upper portion of the first metal layer does not spread to both sides. As a result, a line width of the electrode wirings 30 is narrow while the wiring interval of the plurality of electrode wirings 30 is reduced to 100 μm or less. The first metal layer 32 is preferably made of gold (Au), nickel (Ni), copper (Cu), chromium (Cr), titanium (Ti), or the like; however, may be made of any metal capable of forming a metal layer using a vacuum deposition method.

The second metal layer 34 may be made of a metal having higher electric conductivity than that of the first metal layer 32. The second metal layer 34 is formed to be thicker than the thickness of the first metal layer 32 in order to perform a main role of electric conduction, which may be considered to determine the electric conductivity of the electrode wiring 30. In addition, the high resistance value due to a thin thickness of the first metal layer may be reduced by stacking the second metal layer 34 to be thicker than the thickness of the first metal layer 32.

The second metal layer 34 may be formed to correspond to the width of the first metal layer 32. When the width of the second metal layer 34 is wider than that of the first metal layer 32, the effect of preventing the second metal layer 34 from being spread to both sides is reduced. On the other hand, when the width of the second metal layer 34 is narrower than that of the first metal layer 32, the electric conductivity of the electrode wiring 30 is degraded.

In addition, the second metal layer 34 may be made of silver (Ag). The silver (Ag) has high electric conductivity and excellent workability and mechanical property.

The transparent electrode 20 may be configured in plural while extending in a first direction as shown in FIG. 2A. The transparent parent 20 is formed in plurality, such that a controller can easily recognize points touched by a user as coordinates. In this case, the “first direction” is considered as having constant directivity but may be an X-axis direction, a Y-axis direction, a diagonal direction, etc.

In addition, the transparent electrode 20′ may have a single film shape in the resistive touch panel as shown in FIG. 2C. The resistive touch panel depends on a method of recognizing touched coordinates by conducting the upper/lower transparent electrodes 20′ formed on the base member 10 when the upper base member formed with the upper transparent electrode is pressed by input units such as fingers, pen, etc. and recognizing the change in voltage according to the change in resistance value at the touched position by the controller. As shown in FIG. 2D, an electrode wiring 30′ may be formed by forming a first metal layer 32′ on the side of the transparent electrode 20′ and stacking a second metal layer 34′ on the upper portion of the first metal layer 32′. Although not shown in the drawings, the electrode wirings 30′ may have a structure in which the first metal layer 32′ and the second metal layer 34′ are stacked on the upper portion of the transparent electrode 20′.

As the composition of the transparent electrode 20, transparent conductive oxide (TCO) such as indium tin oxide (ITO), antimony tin oxide (ATO), etc, has been mainly used.

In this case, the composition of the transparent electrode 20 may be a conductive polymer. The conductive polymer is excellent in flexibility and simple in a coating process. The conductive polymer may adopt an organic compound, such as polythiophenes, polypyrroles, polyanilines, polyacetylenes, polyphenylenes, or the like. In particular, among the polythiophenes, PEDOT/PSS compound is most preferable and one or more mixture of the organic compounds may be used.

The base members 10 of the conductive film may use a glass substrate, a film substrate, a fiber substrate, and a paper substrate as a transparent member. Among others, the film substrate may be made of polyethylene terephthalate (PET), polymethylemethacrylate (PMMA), polypropylene (PP), polyethylene (PE), polyethylenenaphatalene (PEN), polycarbonate (PC), polyethersulfone (PES), polyimide (PI), polyvinylalcohol (PVA), cyclic olefin copolymer (COC), stylene polymer, etc., and are not specifically limited thereto.

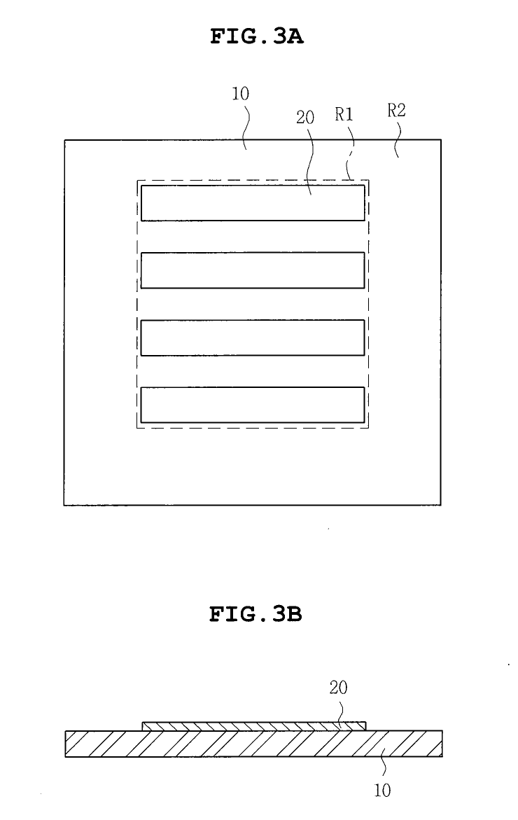

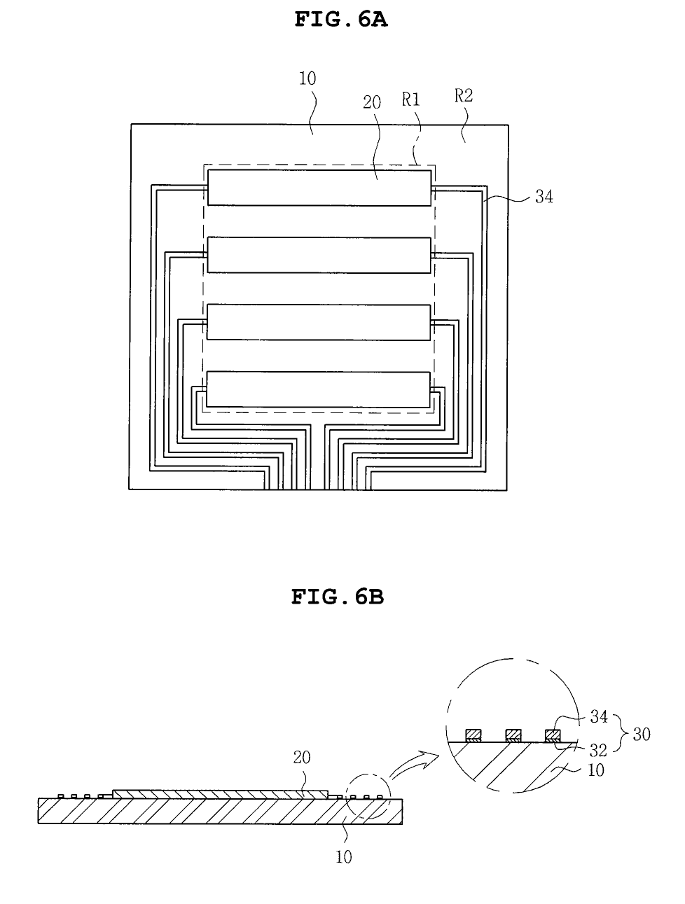

FIGS. 3 and 6 are diagrams showing a method of manufacturing a touch panel according to a preferred embodiment of the present invention. Hereinafter, a method for manufacturing a conductive film according to the present invention will be described with reference to FIGS. 3 to 6.

The description of the overlapping parts with the above-mentioned parts will be omitted.

First, as shown in FIG. 3A, the transparent electrode 20 is formed on the base member 10. The transparent electrode 20 may be configured in plural while extending in a first direction as shown in FIG. 3A. The transparent electrode 20 is a part detecting the change in capacitance when the touch screen is touched by user's fingers. FIG. 3B is a cross-sectional of FIG. 3A.

The transparent electrode 20 may be formed through a dry process or a wet process. As the wet process, sputtering, evaporation, or the like, may be used. As the dry process, dip coating, spin coating, roll coating, spray coating, etc., may be used.

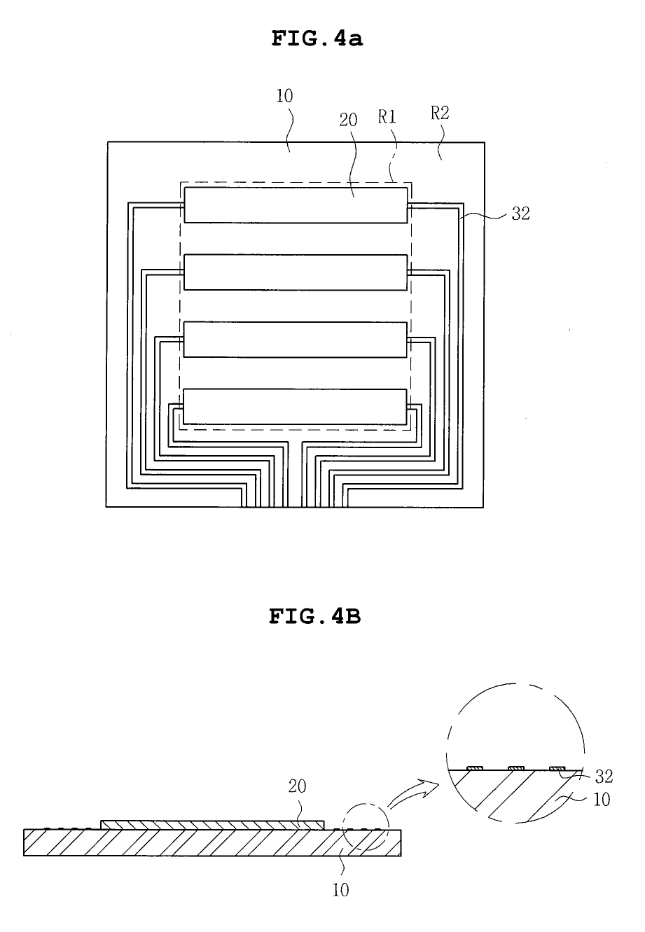

Next, as shown in FIG. 4A, the first metal layer 32 is formed by connecting to one side or both sides of the transparent electrode 20 The first metal layer 32 is formed to be thinner so that the thickness thereof becomes several hundred nm. Since the first metal layer 32 is thinly formed on the base member 10, the wiring interval between the plurality of first metal layers 32 may be finely formed without a risk of short. Further, since the first metal layer 32 serves to prevent the second metal layer 34 from being spread to both sides and the second metal layer 34 performs a main role of electric conduction, manufacturing costs can be reduced by thinly forming the first metal layer 32. FIG. 4B is a cross-sectional of FIG. 4A.

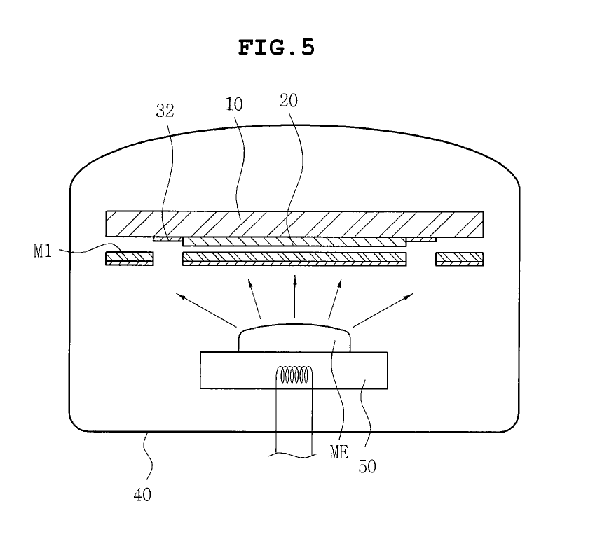

In this case, as shown in FIG. 5, the first metal layer 32 may be formed by the vacuum deposition method. The vacuum deposition method is a method of forming a film by condensing a vaporizing metal or a vaporizing metal compound on the surface of the target material due to the heating and vaporization of metal, metal compound, or alloy An example of the heating method may include a resistive heating method, an electron beam method, a high frequency induction method, a laser method, etc.

The base member 10 is put in a vacuum chamber 40 and then, a mask M1 is disposed on the lower portion of the base member 10. Thereafter, the component metal (ME) of the first metal layer 32 is heated by a heating source 50 to be vaporized or sublimated, such that the first metal layer 32 is formed on the surface of the base member 10 in an atom unit or a molecular unit. The vacuum deposition method can rapidly form the film and easily control the thickness of the film while simplifying the structure.

As shown in FIG. 6B, the electrode wirings 30 are formed by stacking the second metal layer 34 on the upper portion of the first metal layer 32. In the generally used conductive paste, a short may occur between the electrode wirings 30 due to the spreading of the conductive paste to both sides when the electrode wiring 30 is formed to have a predetermined thickness or more by a silk screen method, a gravure printing method, an inkjet printing method, etc., such that the wiring interval cannot be formed at 100 μm or less.

The fine electrode wiring 30 may be manufactured so that the wiring interval between the electrode wiring 30 is 100 μm or less by thinly forming the first metal layer 32 on the base member 10 at several hundred nm and stacking the second metal layer 34 on the upper portion of the first metal layer 32 to prevent the second metal layer 34 from being spread to both sides. The line width is reduced by preventing the second metal layer 34 from being spread to both sides.

The second metal layer 34 is formed to be thicker than the thickness of the first metal layer 32. Since the first metal layer 32 is thinly formed at several hundred nm such that it has a high resistance value, the second metal layer 34 is thickly formed to supplement this. The first metal layer 32 performs the role of the electric conduction but the second metal layer 34 performs the main function of the electric conduction Therefore, the second metal layer 34 may be made of a metal having higher electric conductivity. The second metal layer 34 may be made of silver Ag having high electric conductivity.

In addition, the second metal layer 34 is stacked to correspond to the width of the first metal layer 32. When the width of the second metal layer 34 is narrower than that of the first metal layer 32, the electric conductivity of the electrode wiring 30 is degraded. On the other hand, when the width of the second metal layer 32 is wider than that of the first metal layer 32, it is possible to reduce the effect of preventing the second metal layer 34 from being spread to both sides.

The second metal layer 34 may be stacked by any one of the silk screen method, the gravure printing method, and the inkjet printing method. The electrode wiring 30 is connected to one side or both sides of the transparent electrode 20 to extend to the non-display region R2, such that the distal end thereof is disposed to be gathered at the corner of the conductive film.

Next, although not shown in the drawings, the electrode wiring 30 formed by stacking the second metal layer 34 on the upper portion of the first metal layer 32 is cured. An example of the method of curing the electrode wiring 30 may include a hot air drying method, a vacuum drying method, an infrared (IR) drying method, or the like. The electrode wiring 30 is fixed in a constant shape by curing the electrode wiring 30, such that the deformation thereof is prevented.

As set forth with reference to the conductive film according to the present invention, in forming the electrode wirings on the base member, the electrode wirings are formed by first forming the first metal layer and then stacking the second metal layer supplementing the electric conductivity on the upper portion of the first metal layer to prevent the second metal layer from being spread to both sides due to the first metal layer, thereby making it possible to reduce the line width and the wiring interval of the electrode wirings.

Further, the method for manufacturing a conductive film according to the present invention forms the electrode wirings by forming the first metal layer and stacking the second metal layer on the upper portion of the first metal layer, thereby making it possible to manufacture the electrode wirings having a fine wiring interval while reducing the line width of the electrode wirings. In addition, the second metal layer is formed to be thicker than the thickness of the first metal layer, thereby making it possible to reduce the resistance of the electrode wirings.

Although the preferred embodiments of the present invention have been disclosed for illustrative purposes, they are for specifically explaining the present invention and thus a conductive film and a method for manufacturing the same according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A conductive film, comprising:
a base member;
a transparent electrode formed on the base member; and
electrode wirings connected to one side or both sides of the transparent electrode and having a first metal layer formed on the lower portion thereof and a second metal layer made of a metal different from the first metal layer and formed to be thicker than the thickness of the first metal layer stacked on the upper portion thereof

2. The conductive film as set forth in claim 1, wherein the second metal layer has higher electric conductivity than that of the first metal layer.

3. The conductive film as set forth in claim 1, wherein the second metal layer is formed to correspond to a width of the first metal layer.

4. The conductive film as set forth in claim 1, wherein the first metal layer is made of any one of gold (Au), nickel (Ni), copper (Cu), chromium (Cr), and titanium (Ti).

5. The conductive film as set forth in claim 1, wherein the second metal layer is made of silver (Ag).

6. The conductive film as set forth in claim 1, wherein the transparent electrode is formed in plural while extending in a first direction.

7. The conductive film as set forth in claim 1, wherein the transparent electrode is formed in a single film shape.

8. The conductive film as set forth in claim 1, wherein the transparent electrode is made of a conductive polymer.

9. The conductive film as set forth in claim 8, wherein the conductive polymer is any one of polythiophenes, polypyrroles, polyphenylenes, polyanilines, and polyacetylenes.

10. A method for manufacturing a conductive film, comprising:
(A) forming a transparent electrode on a base member;
(B) forming a first metal layer by connecting to one side or both sides of the transparent electrode;
(C) forming electrode wirings on the upper portion of the first metal layer by stacking a second metal layer thicker than that the thickness of the first metal layer; and
(D) curing the electrode wirings.

11. The method for manufacturing a conductive film as set forth in claim 10, wherein at step (A), the transparent electrode is formed in plural while extending in a first direction.

12. The method for manufacturing a conductive film as set forth in claim 10, wherein at step (A), the transparent electrode is formed in a single film shape.

13. The method for manufacturing a conductive film as set forth in claim 10, wherein at step (B), the first metal layer is formed by a vacuum deposition method.

14. The method for manufacturing a conductive film as set forth in claim 10, wherein at step (C), the second metal layer is stacked to correspond to a width of the first metal layer.

15. The method for manufacturing a conductive film as set forth in claim 10, wherein at step (C), the second metal layer is stacked by any one of a silk screen method, a gravure printing method, and an inkjet printing method.
